(19) United States
(12) Patent Application Publication
(10) Pub. No.: US 2024/0066483 A1
(43) Pub. Date: Feb. 29, 2024

(54) ADDITIVE CONTAINERS

(71) Applicant: SharkNinja Operating LLC, Needham, MA (US)

(72) Inventor: Thomas James Launders, London (GB)

(21) Appl. No.: 17/899,886

(22) Filed: Aug. 31, 2022

(51) Int. Cl. B01F 35/43; A23L 2/54; B01F 23/236; B01F 35/71

(52) U.S. Cl. CPC B01F 35/43; A23L 2/54; B01F 23/2362; B01F 35/7176; B01F 2101/14

(57) ABSTRACT

A dispenser for preparing beverages are provided. In one embodiment, the dispensing system includes a housing, a carbonation assembly disposed within the housing, and a drawer slidably mounted to the housing. The carbonation assembly is configured to selectively carbonate a fluid. The drawer is configured to seat at least one additive container. The dispensing system is configured to selectively dispense an additive contained within an additive container in the drawer from a first outlet, and is configured to dispense a fluid from a second outlet separate from the first outlet.

### FIELD

Beverage dispensing systems, components, and additive containers for use with beverage dispensing systems are provided.

### BACKGROUND

Conventional beverage dispensing devices operate to carbonate and/or flavor water.

Some devices may mix carbonated water and a flavoring compound together in a machine and then dispense the resulting mixture into a receptacle. Unless the devices are thoroughly cleaned, this method can result in contamination occurring over time. Other devices rely on crushing, puncturing, and/or generally compromising flavoring containers in order to access the flavoring compounds inside. These methods of breaching flavoring containers can result in splatter and mess, which, if not thoroughly cleaned, can result in similar contamination.

Still other devices rely on carbonating water within a specialized container to be attached to the device, and from which the resulting beverage is served. The container can be pre-filled with water and/or flavoring, and then it can be secured to the devices and pressurized within the container and used to serve the resulting beverage. These devices require specially adapted bottles that interface with the device.

Accordingly, there remains a need for improved methods and devices for preparing beverages.

### SUMMARY

Various beverage dispensing system and additive containers for use with beverage dispensing systems are provided.

In one embodiment, a dispensing system is provided. The dispensing system can include a housing, a carbonation assembly disposed within the housing, and a drawer slidably mounted to the housing. The carbonation assembly can be configured to selectively carbonate a fluid, and the drawer can be configured to seat at least one additive container. The dispensing system can be configured to selectively dispense an additive contained within an additive container in the drawer from a first outlet and can dispense a fluid from a second outlet separate from the first outlet.

One or more of the following features can be included in any feasible combination. For example, the drawer can be slidably movable horizontally between an open position in which an additive container can be top-loaded into the drawer and a closed position in which the drawer is fully disposed within the housing. In another example, the drawer can be configured to seat a plurality of additive containers. In certain aspects, the drawer can be configured to seat a plurality of additive containers in one of a radial formation and a linear formation. In other aspects, the second outlet can be centrally disposed, and the drawer can be configured to seat the plurality of additive containers peripherally of the first outlet.

In another example, the dispensing system can be configured to selectively introduce at least one gas into an additive container seated in the drawer to cause the additive container to dispense the additive from the first outlet. In certain aspects, the drawer can include at least one inlet port fluidly coupled to a pump. The pump can be configured to selectively introduce the at least one gas into an additive container.

In another example, the drawer can include at least one viewing window configured to enable viewing of an additive container in the drawer when the drawer is in a closed position.

In another embodiment, a dispensing system is provided. The dispensing system can include a housing, a carbonation assembly at least partially contained within the housing, and a top-loading carriage assembly coupled to the housing. The carbonation assembly can be configured to selectively carbonate a fluid. The top-loading carriage assembly can be configured to receive at least one additive container. The dispensing system can be configured to dispense an additive disposed within an additive container in the carriage assembly to dispense a fluid that is selectively carbonated by the carbonation assembly into a receptacle.

One or more of the following features can be included in any feasible combination. For example, the top-loading carriage assembly can include an inlet port fluidly coupled to at least one air pump and can be configured to selectively introduce at least one gas into an additive container in the carriage assembly to cause the additive container to dispense an additive. In certain embodiments, the top-loading carriage assembly can include a lid movable between an open position and a closed position. The lid, in the closed position, can be configured to apply a force to an additive container in the carriage assembly to couple an inlet port in the additive container with an outlet port in the housing.

In another example, the top-loading carriage assembly can include a plurality of isolated silos. Each of the isolated silos can be configured to seat an additive container. In certain aspects, each of the isolated silos can include an inlet port and an outlet port. Each of the inlet ports can be configured to allow at least one gas to be introduced into an additive container in the silo to cause the additive container to dispense an additive from the respective outlet port. In other aspects, each of the isolated silos can be independently pressurizable to cause an additive container therein to compress and dispense an additive.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

These and other features will be more readily understood from the following detailed description taken in conjunction with the accompanying drawings, in which:

FIG. 1 is a front view of one embodiment of a beverage dispensing system;

FIG. 2 is a side perspective view of the beverage dispensing system of FIG. 1;

FIG. 3 is a rear perspective view of the beverage dispensing system of FIG. 1, having various housing elements removed;

FIG. 4A is a side perspective view of one embodiment of a carriage assembly for use in a beverage dispensing system;

FIG. 4B is a side perspective view of the carriage assembly of FIG. 4A in an open configuration;

FIG. 4C is a side perspective view of the carriage assembly of FIG. 4A with an additive container about to be inserted into the carriage assembly;

FIG. 5A is a side perspective view of a carriage assembly according to another embodiment;

FIG. 5B is a side perspective view of the carriage assembly of FIG. 5A in an open configuration;

FIG. 5C is a partially-transparent side perspective view of the carriage assembly of FIG. 5A;

FIG. 5D is a partially-transparent side view of the carriage assembly of FIG. 5A having an additive container contained therein;

FIG. 6A is a front view of a carriage assembly having a plurality of viewing windows according to another embodiment;

FIG. 6B is a top view of the carriage assembly of FIG. 6A containing several additive containers disposed in a radial formation;

FIG. 6C is a front view of another embodiment of a carriage assembly having a plurality of viewing windows;

FIG. 6D is a top view of the carriage assembly of FIG. 6C containing several additive containers disposed in a linear formation;

FIG. 6E is a partial perspective front view of a carriage assembly having a thermometer-shaped viewing window according to another embodiment;

FIG. 7A is a perspective side view of one embodiment of an additive container having an angled neck;

FIG. 7B is a right side view of the additive container of FIG. 7A;

FIG. 8A is side perspective view of an additive container having a piston system;

FIG. 8B is a top perspective view of the additive container of FIG. 8A;

FIG. 8C is a top view of a carriage assembly containing several of the additive container of FIG. 8A;

FIG. 8D is a partial cross-sectional side view of a dispensing process of the additive container of FIG. 8A;

FIG. 9A is a perspective view of an additive container having a container made with a Blow-Fill-Seal process and a lid;

FIG. 9B is a partial side view of an assembly process of the additive container and lid of FIG. 9A;

FIG. 9C is a partial side view of the assembly process of FIG. 9B where a piercing element on the lid has pierced a seal on the container;

FIG. 9D is a partial side view of the assembly process of FIG. 9B where the lid is snapped into position

FIG. 10A is a side perspective view of an additive container having a collapsible body coupled to an actuator;

FIG. 10B is a side view of the additive container and actuator of FIG. 10A;

FIG. 11A is a top perspective view of a collapsible additive container according to an embodiment;

FIG. 11B is a top perspective view of the collapsible additive container of FIG. 11A being loaded into a pressurizable carriage assembly;

FIG. 12A is a side view of an embodiment of an additive container having a bag-on-valve design according to an embodiment;

FIG. 12B is a side view of an additive container having a bag-on-valve design and an extended spout according to another embodiment;

FIG. 12C is a side view of an additive container, showing an illustrative process of preparing an additive container having a bag-on-valve design involving placing a valve and bag inside a container;

FIG. 12D is a side view of the additive container of FIG. 12C, showing a step involving crimping and gassing procedures;

FIG. 12E is a side view of the additive container of FIG. 12C, showing another step involving a pressure control procedure;

FIG. 12F is a side view of the additive container of FIG. 12C, showing another step involving a product filling and weight control procedure;

FIG. 12G is a side view of the additive container of FIG. 12C, showing another step involving an actuator and cap placement procedure;

FIG. 13A is a side perspective view of an additive container compatible with a peristaltic pump feature according to another embodiment;

FIG. 13B is a side perspective view of the additive container of FIG. 13A loaded into a carriage assembly having a peristaltic pump feature according to an embodiment;

FIG. 13C is a side perspective view of the additive container of FIG. 13A loaded into a carriage assembly having a peristaltic pump feature according to another embodiment;

FIG. 14A is a side view of an additive container having an additive detected via an infrared level detector;

FIG. 14B is a side view of the additive container of FIG. 14A where the infrared level detector detects a low additive volume;

FIG. 14C is a side view of an additive container having an additive detected via a non-contact liquid level indicator according to an embodiment; and

FIG. 14D is a side view of the additive container of FIG. 14C where the non-contact liquid level indicator detects a low additive volume.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Certain illustrative embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting illustrative embodiments and that the scope of the present invention is defined solely by the claims. The features illustrated or described in connection with one illustrative embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape.

Various additive containers for use with beverage dispensing systems are provided. In general, the additive container can contain any additive, such as a flavorant, vitamin, or other substance to be added to a beverage or other liquid food supply, for use in a beverage dispensing process. The additive container can have a hollow container body with a cap or other closure coupled to or formed on the container body. The cap can include a fluid outlet therein. In some embodiments, the cap can further include a cover configured to selectively close the fluid outlet, thereby sealing a hollow interior of the container body. The additive container can be configured to be received in a beverage dispensing device. In certain illustrative embodiments, the beverage dispensing device can include a carriage for receiving the additive. Accordingly, various embodiments of carriages are also provided herein. The carriage can have complimentary features to receive and retain the additive container, and when retained, the additive container can be employed by the beverage dispensing device for use in the creation of customized beverages.

Methods of dispensing the additive stored within the additive container can vary. In some embodiments, the additive container can be pressurized with gas via a fluid inlet in the cap to cause the fluid outlet to open and dispense the stored additive. When the additive container is properly seated and retained by a carriage, a gas line fluidly coupled to a pump can receive the fluid inlet of the additive container in order to seal around the inlet in preparation for the introduction of gas into the additive container during a dispensing procedure. Once a customized beverage is created using an additive stored within the additive container, gas can be pumped by the pump, though the gas line, through an inlet seal in the fluid inlet, and into the hollow interior of the additive container. The resulting increase in internal pressure can cause an outlet seal in the fluid outlet to open and dispense an amount of the additive proportional to the amount of air introduced through the inlet. Other techniques for ejecting fluid from an additive container are also provided.

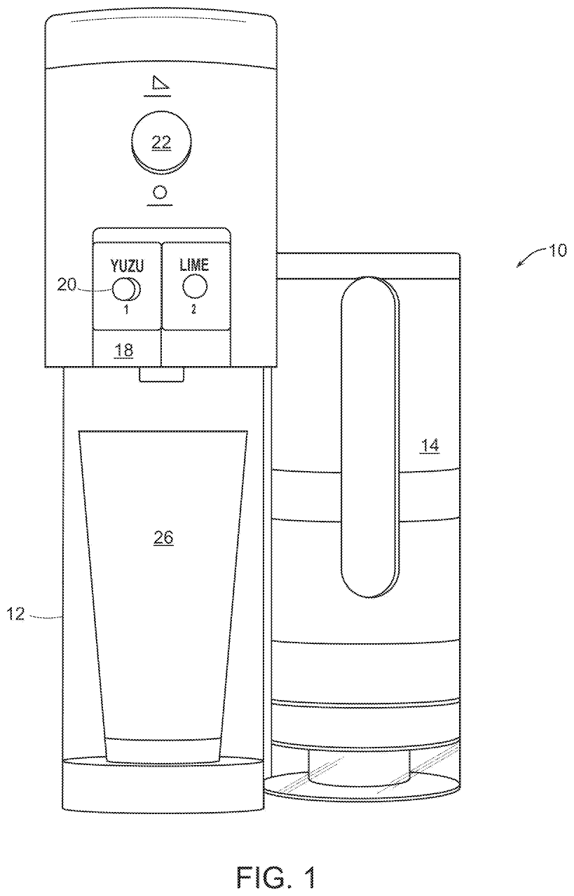

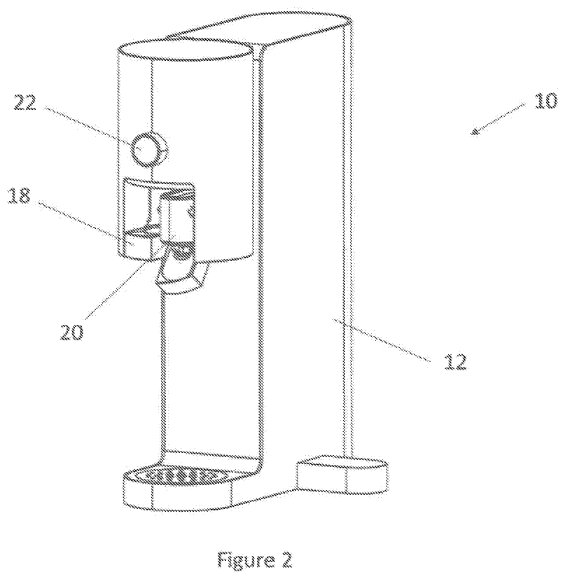

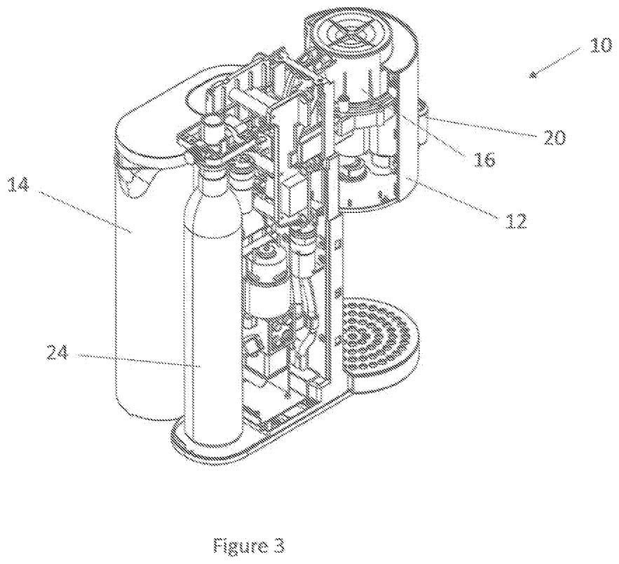

FIGS. 1-3 illustrate one illustrative embodiment of a beverage dispensing system 10. The beverage dispensing system 10 can be used to create and dispense customized beverages for a user, based on desired characteristics of the beverage. The illustrated beverage dispensing system 10 generally includes a housing 12 having a fluid reservoir 14 and a carbonation assembly 16. In certain embodiments, the fluid reservoir 14 can be coupled to the housing 10 in a removable manner, such as in the form of a water tank, pitcher, and the like. Such a configuration can allow the reservoir to be stored in a refrigerator when not in use, thus allowing for the use of chilled fluid during the carbonation process. The carbonation assembly 16 can use liquid, e.g., water, contained in the fluid reservoir and mix it with carbon-dioxide in order to carbonate the liquid. The carbon-dioxide can be sourced from a canister 24, or it may come from another source, such as from a chemical process to generate carbon-dioxide, or any other source.

The carbonation assembly 16 is configured to mix a liquid with CO₂ to form a treated fluid in the form of a carbonated fluid intended to be a beverage. A carbonation assembly is one example of a treatment assembly of a beverage dispensing system. Other treatment assemblies can be used with the beverage dispensing systems described herein. Treatment assemblies that do not use CO₂ are generally configured and used similar to the carbonation assemblies described herein except instead of mixing CO₂ with a liquid, a different gas is mixed with the liquid. The resulting fluid is a treated fluid but is not a “carbonated” fluid.

A carriage assembly 18 can be coupled to the beverage dispensing system 10, and it can receive one or more additive containers 20 to be used in the creation of beverages. The carriage assembly 18 can be located anywhere on or in the beverage dispensing system 10, and it can be fixedly, movably, or removably coupled thereto.

The additive containers 20 can contain one or more additives to be mixed into a beverage dispensed by the beverage dispensing system 10, as indicated above. The one or more additives can be mixed in the beverage dispensing system 10, or they can be dispensed from the beverage dispensing system 10 separately and mixed in a drinking container 26, e.g., a cup, a bottle, etc. The one or more additives contained in an additive container 20 can take any physical form, such as a solid, liquid, or gas, or a compound thereof, and the additive can be a flavorant, a color or dye, a vitamin, supplement, or any other type of ingredient or compound to be added to a beverage. In general, the additive container 20 can include a cap coupled to a container. The cap can include at least one valve thereon to permit the outflow of the additive.

To dispense a beverage, in an illustrative process, a user can first ensure that the beverage dispensing system 10 is properly set up. This set up process can include filling the fluid reservoir, connecting, prepping, or priming a carbon-dioxide source, e.g., canister 24, and then loading one or more additive containers 20 into the carriage assembly 16.

Once the beverage dispensing system is set up, a user can actuate inputs located at a user interface 22 in order to select specific characteristics of their desired beverage. These characteristics can include volume, carbonation level, and additive type (i.e., if one or more additive containers 20 is retained in the carriage assembly 18), and additive amount. If the user selects inputs to indicate that the beverage is carbonated, water can be fed from the fluid reservoir 14 and into the carbonation assembly 16, and carbon-dioxide can be fed from the canister 24, for example, and into the carbonation assembly 16 to produce carbonated water. If the user selects inputs to indicate that the additive should be added to the beverage, the beverage dispensing system 10 can dispense the additive from the one or more additive containers 20 coupled to the system. The beverage can be dispensed into a container, such as a drinking glass 26, or equivalent such as a travel mug, bottle, jar, mug, etc.

The specific details related to set up, characteristic selection at a user interface, and beverage creation can vary, depend upon the specific layout of the beverage dispensing device 10. For example, in embodiments that do not rely on carbon-dioxide, and instead rely on a different gas (e.g., nitrogen), the above-described steps related to carbon-dioxide and carbonation can be adjusted or omitted as necessary.

Illustrative embodiments of beverage dispensing systems are disclosed in more detail, for example, in U.S. patent application Ser. No. 17/744,459, filed on May 13, 2022, and entitled “FLAVORED BEVERAGE CARBONATION SYSTEM,” which is incorporated by reference herein in its entirety.

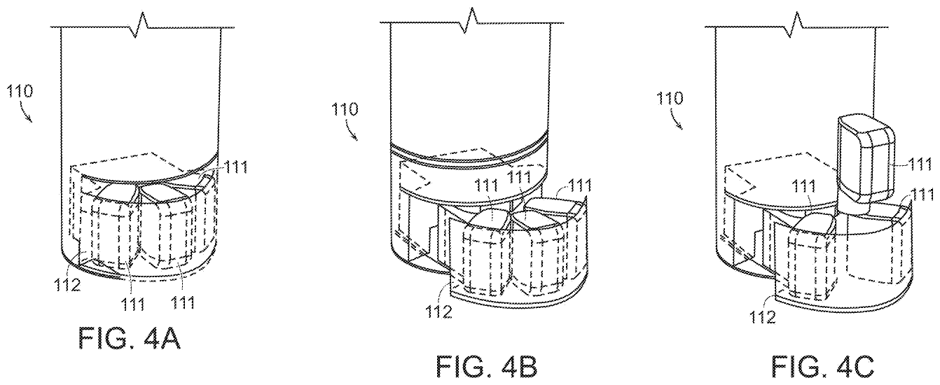

In various embodiments, as introduced, the specific layout of the carriage assembly can vary. FIGS. 4A-6E illustrate various embodiments of carriage assemblies and features thereof.

FIG. 4A-4C depict a carriage assembly 110 capable of receiving and seating one or more additive containers, according to an embodiment. The carriage assembly 110 can be located in a housing (e.g., housing 12), and it can take the general form of a sliding drawer 112. The carriage assembly 110 can slide between a closed position, seen in FIG. 4A, and an open position, seen in FIGS. 4B and 4C. One or more additive containers 111 can be placed inside the carriage assembly 110 for use during a beverage dispensing process. The drawer 112 can be placed upon one or more tracks (not shown) located within the housing, in order to facilitate opening and closing thereof.

The additive containers 111 are depicted as being arranged in a radial formation, however other formations, including linear, stacked, etc., are also possible. In some variations, the carriage assembly 110 can include a handle (not shown) or some means to assist a user in opening and closing the carriage assembly 110.

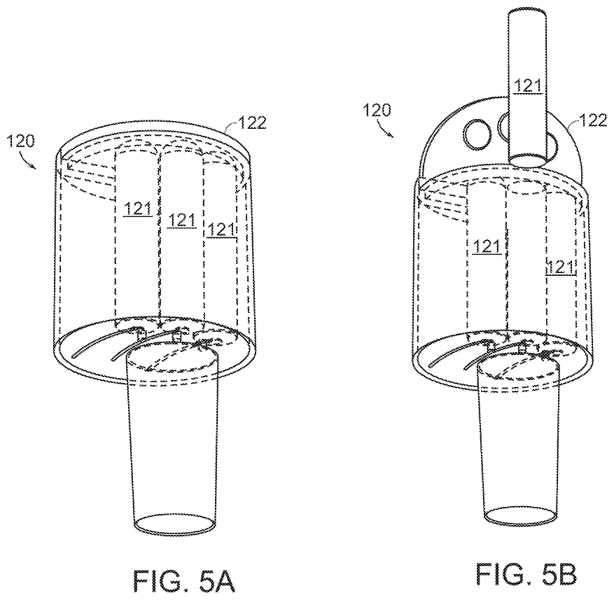

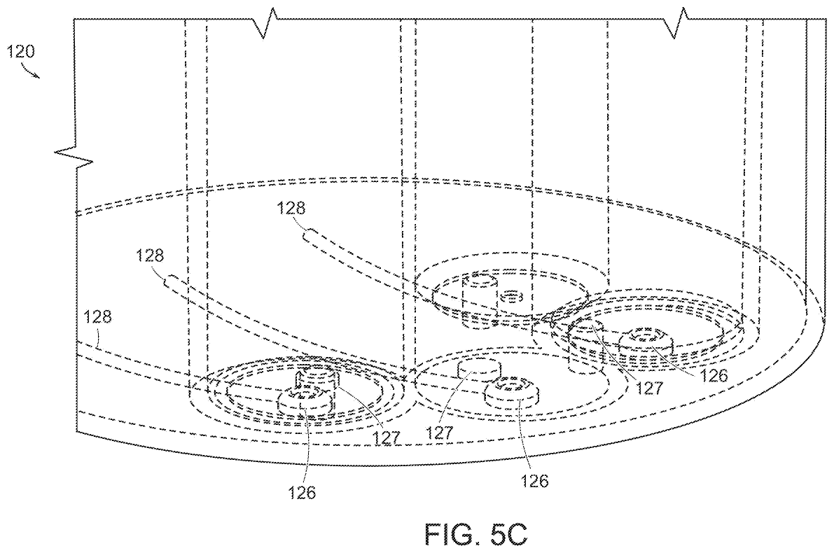

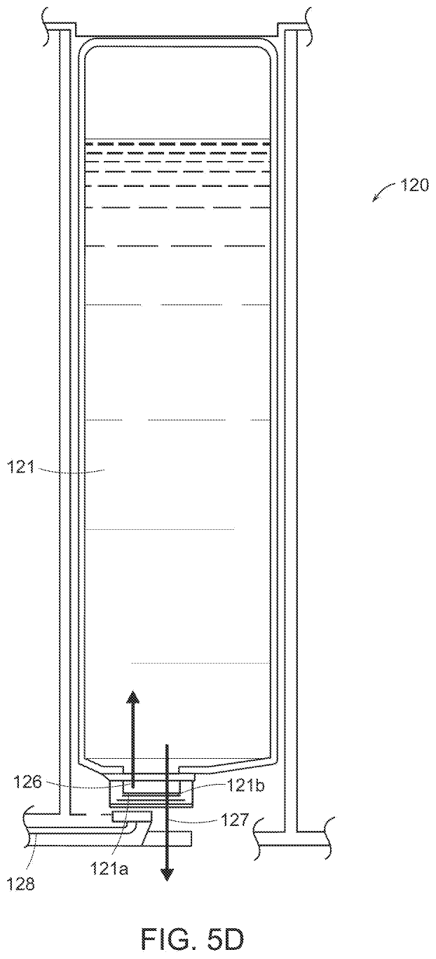

FIG. 5A-5D depict a carriage assembly 120 according to an embodiment. The carriage assembly 120 can be a top-loading carriage assembly 120 located in a housing (e.g., housing 12). A lid 122 can be hinged to the housing, which can be opened to load one or more additive containers 121 into the carriage assembly 120, as shown in FIG. 5B. FIG. 5C depicts a close-up view of a plurality of carriages located in the carriage assembly 120, with each having an inlet port 126 and an outlet port 127. Each of the inlet ports 126 has an airline 128 fluidly coupled thereto for introducing gas into a seated additive container (e.g., additive container 121). The airlines 128 can lead to one or more gas sources (not shown). As shown in FIG. 5D, the additive container 121 can have an inlet 121a resting upon an inlet port 124 and an outlet 121b resting upon an outlet port 126. In operation, one or more additive containers 121 can be lowered into the carriage assembly 120. The lid 122 can be closed, which can press the one or more loaded additive containers 121 onto the inlet port 126 and outlet port 127 in order to seal the additive containers 121 thereon. When a beverage dispensing process is initiated that involves dispensing an additive, air can be introduced to the relevant additive container 120 or additive containers 120 to build up internal pressure and force out the additive.

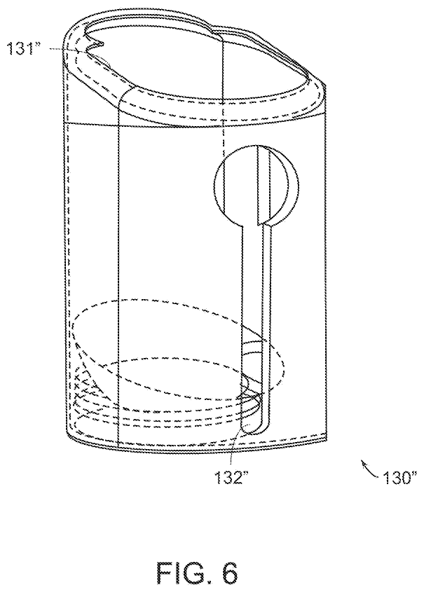

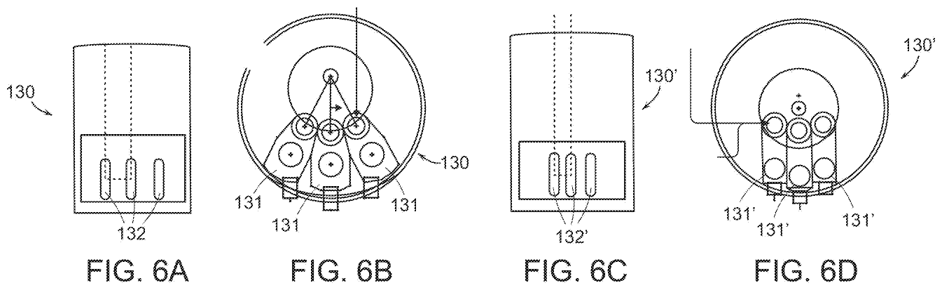

In certain embodiments, the carriage assembly (e.g., carriage assembly 18, 110, 120, etc.) can include one or more viewing windows to allow a user to visually inspect one or more retained additive containers while the additive containers are seated within the carriage assembly. FIGS. 6A-6E depict various embodiments of such viewing windows.

FIGS. 6A and 6B depict a carriage assembly 130 configured to seat and arrange one or more additive containers 131 in a radial formation. The carriage assembly 130 can include one or more viewing windows 132 on an outer portion thereof, which can allow a user to visually inspect each of the one or more seated additive containers 131. The viewing windows 132 can be arranged to align with the radial formation.

FIGS. 6C and 6D depict a carriage assembly 130′ configured to seat and arrange one or more additive containers 131′ in a linear formation. The carriage assembly 130′ can include one or more viewing windows 132′ arranged to align with the linear formation of the one or more seated additive containers 131′.

FIG. 6E depicts a carriage assembly 130″ with a viewing window 131″ having a thermometer-type shape. The viewing window 131″ can be included on any carriage assembly described herein. Additive containers, for example additive containers 131, 131′, 131″ and any other additive container, can be made from transparent and/or semi-transparent material, which can allow for a user to more easily see an additive contained therein.

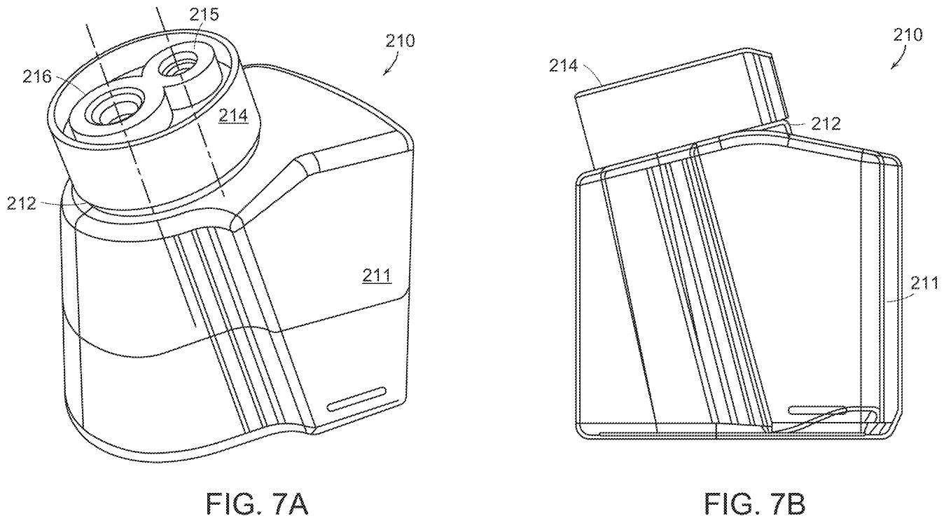

With reference now to FIGS. 7A-15D, illustrated are additive containers and features thereof according to various embodiments.

FIGS. 7A-7B depict an embodiment of an additive container 210 having an angled neck 212. The additive container 210 generally includes a container 211 containing an additive (not shown). A lid 214 is disposed on the angled neck 212, and the lid can include an inlet 215 and an outlet 216 thereon. As a result of the angled neck 212, the lid 214, including the inlet 215 and the outlet 216, are angled relative to the container 211 of the additive container 210.

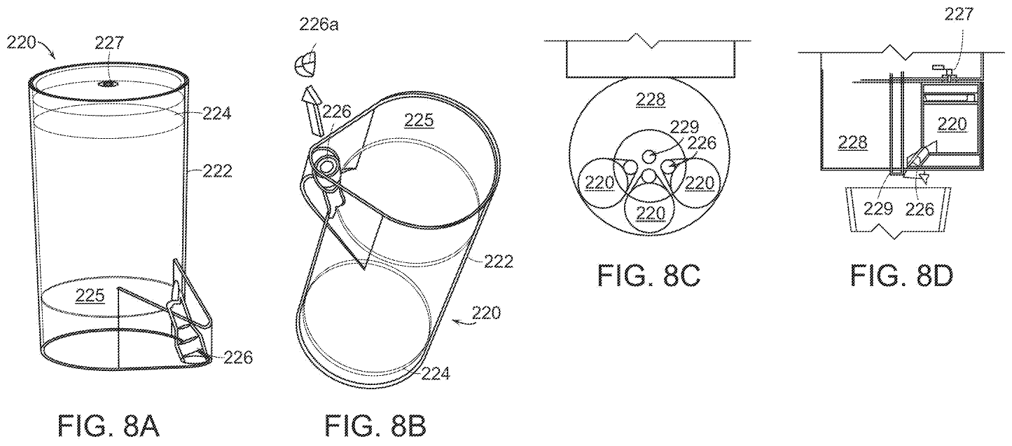

FIGS. 8A-8D depicts an embodiment of an additive container 220 having a built-in piston (also referred to herein as a “plunger”). The additive container 220 can have a cylindrical body 222 defining an interior chamber containing an additive, and can include a plunger 224 disposed therein. The additive container 220 can include a skirt 225 an outlet 226 fluidly coupled to the interior chamber in order to facilitate dispensing the additive. The outlet 226 can be sealed by a removable foil 226a. The plunger 224 can be physically actuated by an element pressing down on the plunger 224 to cause the outlet 226 to emit fluid. In certain embodiments, the additive container 220 can also include an air inlet 227 for receiving air. In such embodiments, the additive container 220 can be seated in a carriage assembly 228 and then air can be introduced through the air inlet 227. The introduced air can case the plunger 224 to be actuated as a result of an increase in pressure within the body 222 received via the air inlet 227. The actuator of the plunger 224 in this manner can cause the outlet 227 to dispense the stored additive.

When one or more additive containers 220 are seated in a carriage assembly 228, they can be arranged in a radial formation such that their respective outlets 226 are arranged close to each other, as seen, for example, in FIG. 8C. A separate outlet 229 can be disposed centrally of the outlets 226 for dispensing still and/or carbonated water.

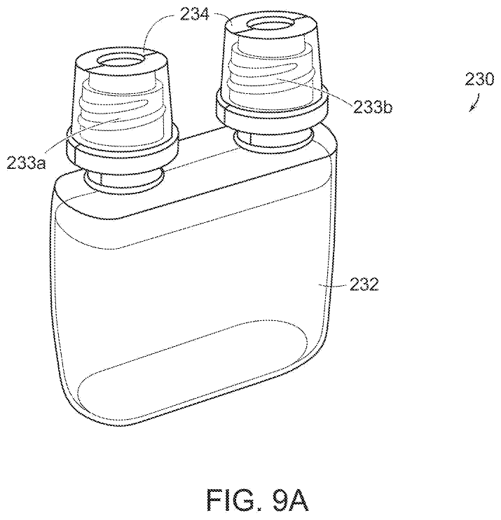

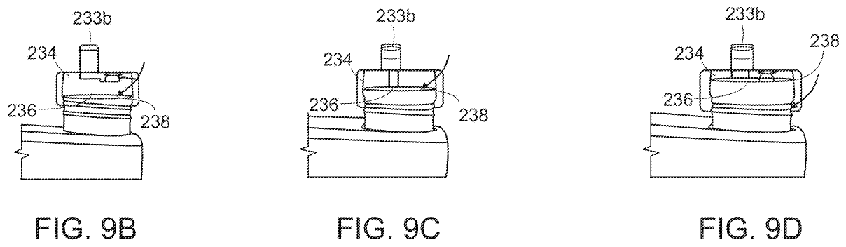

In certain embodiments, an additive container can be formed using a Blow-Fill-Seal manufacturing process. FIGS. 9A-9D illustrates an embodiment of an additive container 230 manufactured according to such a process. The additive container 230 can include a container 232 and one or more lids 234. The container 232 can be manufactured to include an inlet 233a and an outlet 233b, filled with an additive, and sealed with one or more seals 238 over each of the inlet 233a and the outlet 233b, as shown in FIG. 9B. The lids 234 with a piercing element 236 can be manufactured separately. When a user is ready to use the additive container 230, the user can attach the one or more lids 234 to the container 232 over the inlet 233a and/or the outlet 233b, piercing the seal 238 with the piercing element 236 in the process, as shown in FIG. 9C, and enabling access to the additive stored inside with the lid 234 snapped into a seated position, as shown in FIG. 9D. In certain embodiments, the container 232 can omit an inlet 233a and can only include an outlet 233b. In such embodiments, only one lid 234 can be used.

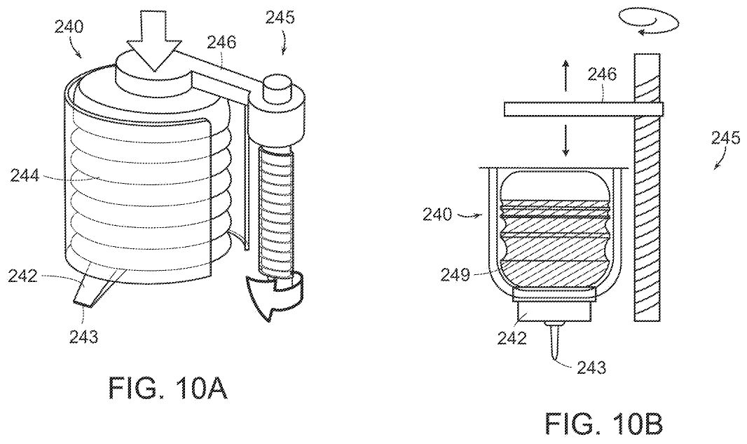

FIGS. 10A-10B illustrates an additive container 240 according to another embodiment. The additive container 240 can include a lid 242 coupled to a container 244 containing an additive. The container 244 can be shaped to include an accordion-like body that, when compressed, causes the additive to be emitted through the lid 242 via an outlet 243. The additive container 240 can be placed in a carriage assembly 245 having a screw-driven armature 246 that can be driven to compress the container 244. A sensor (not shown) can be in mechanical and/or electrical communication with the armature 246 to monitor a height of the armature relative to the container 244, corresponding to a compression level of the container 244. In this way, an alert or message can be sent to a user and/or other individual to provide information related to the fill-level of the additive container 240.

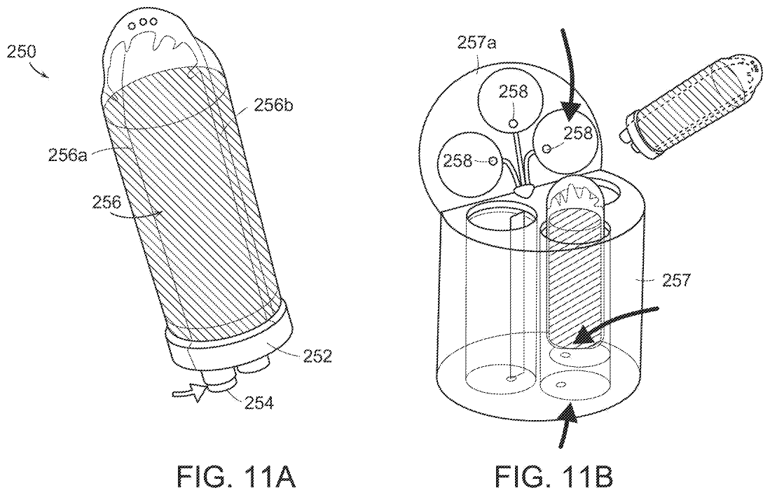

FIGS. 11A-11B illustrates an additive container 250 according to another embodiment. The additive container can include a lid 252 having an outlet 254. The lid 252 can be coupled to a pouch 256, which can include a flexible material 256a and can also include a rigid frame 256b. To dispense an additive contained in the pouch 256, the pouch 256 can be compressed in a variety of ways, including by a physical means, such as a piston, a clamp, etc. In certain embodiments, the additive container 250 can be placed inside a pressurizable carriage assembly 257. The outlet 254 can dock in an opening at a lower end of the carriage assembly 257 and can seal off the opening such that the carriage assembly 257 is airtight. A lid 257a can then be closed to seal an upper end of the carriage assembly 257. During operation of a beverage dispensing device, the carriage assembly 257 can be pressurized to a pressure greater than an internal pressure of the pouch 256 by the introduction of air or another gas through an airline 258 or equivalent. This pressure differential can cause the pouch 256 to compress, thereby dispensing the additive as desired.

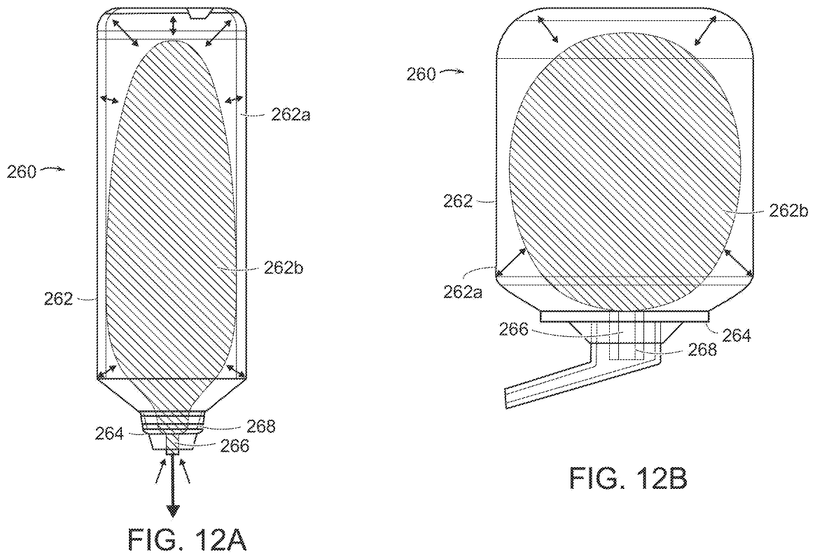

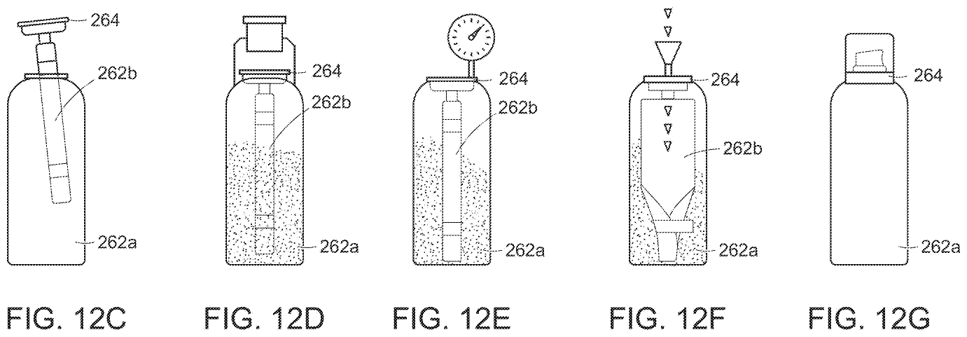

FIGS. 12A-12B illustrates an additive container 260 according to another embodiment. The additive container can include a container 262 having an outer shell 262a and an inner pouch or bag 262b. A lid 264 with a releasable valve 266 can be coupled to an outlet 268 of the bag 262b. The additive container 260 can be manufactured and filled in such a way that the space between the outer shell 262a and the bag 262b is at an elevated but contained pressure. The bag 262b can be filled with an additive and can have an internal pressure that is less than the pressure between the outer shell 262a and the bag 262b. In order to dispense the additive, the releasable valve 266 can be actuated, and the pressure differential within the additive container can force the additive out of the outlet 268 as desired.

FIGS. 12C-12G illustrate an illustrative process for manufacturing the additive container 260 of FIGS. 12A-12B. The bag 262b can be inserted into the outer shell 262a, and the outer shell 262a can then be pressurized before being sealed off by the lid 264. The bag 262b can then be filled with an additive to cause the bag 262b to inflate within the pressurized outer shell 262a, thereby increasing an internal pressure of the shell 262a interior even further. From there, the additive can be sealed until use.

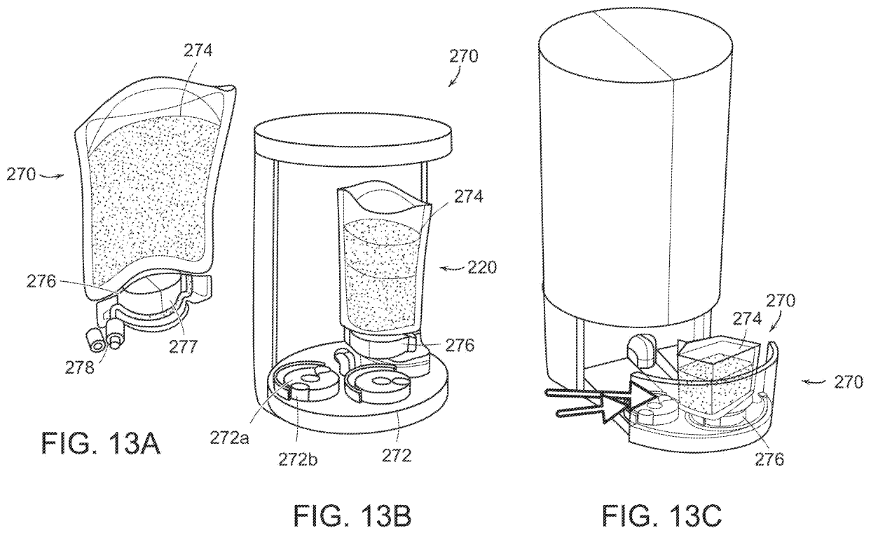

FIGS. 13A-13C illustrates an additive container 270 according to another embodiment that is configured to be usable with a peristaltic pump 272. The additive container 270 can include a flexible pouch 274 with a lid 276 coupled thereto. Leading away from the pouch 274 and extending around a perimeter of the lid 276 can be a hose 277 that terminates in an outlet 278. The additive container 270 can be placed within a carriage assembly 271 that includes a peristaltic pump 272. The peristaltic pump 272, as will be appreciated by a person skilled in the art, can include a rotor 272a with at least one roller 272b coupled thereto. When the additive container 270 is used to dispense the additive, the rotor 272a can rotate, causing the at least one roller 272b to roll along the hose 277, drawing the additive out of the pouch 274 as required for the desired beverage. The carriage assembly 271 can be equipped to receive one or more additive containers 270 that are independently operable to pump stored additives therefrom.

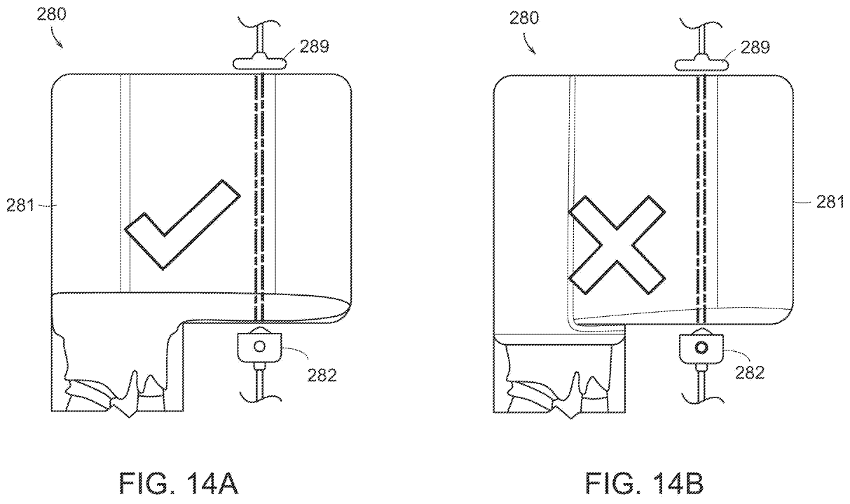

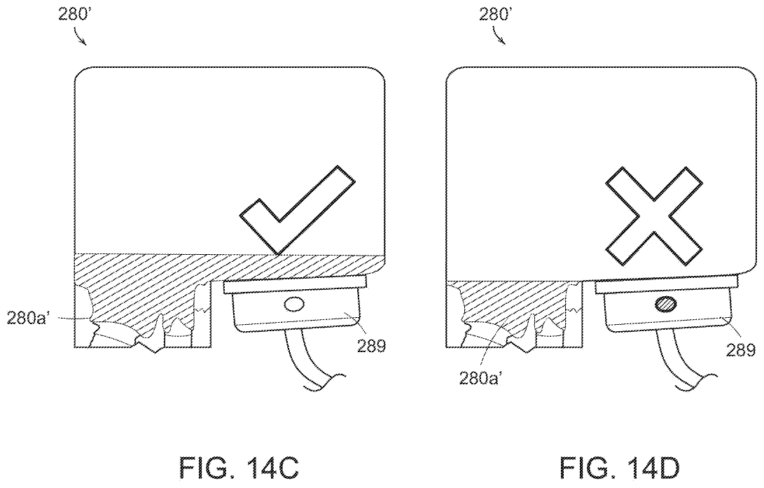

In certain embodiments, an additive container, such as those described herein, can include a level indicator having various forms. For example, FIGS. 14A-14B depict an additive container 280 that is configured to interface with an infrared sensor 282 capable of discerning an amount of additive remaining in the additive container 280. The additive container 280 can include a container 281 made of a material that is substantially non-absorbent of infrared radiation, and the additive container 280 can contain an additive that at least partially absorbs and/or scatters infrared radiation. An infrared emitter 284 (e.g., an infrared lamp, a laser diode, filtered light, etc.) can be located within a carriage assembly and aimed at the infrared sensor 282. When the additive container 280 is seated in the carriage assembly, the infrared sensor 282 can be prevented from receiving a signal emitted by the infrared emitter 284 while the additive container 280 still contains a certain amount of additive. As additive is dispensed from the additive container 280, the additive can scatter less and less infrared radiation until, at a certain volume, the infrared sensor 282 is capable of detecting the infrared radiation emitted by the infrared emitter 284. A beverage dispensing device employing the infrared sensor 282 can, depending on the strength of the received infrared signal, output a message (e.g., visible, audible, etc.) to a user informing them of an additive volume in the additive container 280. For example, if the signal is able to pass through a seated additive container 280, the message can inform the user that the additive volume is low.

In certain embodiments, the level indicator can be in the form of a non-contact liquid level indicator 289, seen, for example, in FIGS. 14C-14D. The non-contact level indicator 289 can be positioned in a carriage assembly, such that when an additive container 280′ is retained therein, the non-contact level indicator contacts the additive container 280′. The non-contact level indicator can be capable of detecting an additive located inside the additive container 280′, and the non-contact level indicator 289 can be positioned relative to the additive container 280′ in such a way that the non-contact level indicator can detect when the additive has reached a low volume. For example, in embodiments where the additive container 280′ includes a neck 280a′, the non-contact level indicator 289 can be positioned on the additive container 280′ such that when the additive reaches a low volume, the additive may only pool in the neck 280a′ away from the non-contact level indicator 289, as seen in FIG. 14D.

Certain illustrative implementations have been described to provide an overall understanding of the principles of the structure, function, manufacture, and use of the systems, devices, and methods disclosed herein. One or more examples of these implementations have been illustrated in the accompanying drawings. Those skilled in the art will understand that the systems, devices, and methods specifically described herein and illustrated in the accompanying drawings are non-limiting illustrative implementations and that the scope of the present invention is defined solely by the claims. The features illustrated or described in connection with one illustrative implementation may be combined with the features of other implementations. Such modifications and variations are intended to be included within the scope of the present invention. Further, in the present disclosure, like-named components of the implementations generally have similar features, and thus within a particular implementation each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described implementations. Accordingly, the present application is not to be limited by what has been particularly shown and described, except as indicated by the appended claims. All publications and references cited herein are expressly incorporated by reference in their entirety.

1. A dispensing system, comprising:
a housing;
a carbonation assembly disposed within the housing and configured to selectively carbonate a fluid to form a carbonated fluid; and
a drawer slidably mounted to the housing and having a seat configured to seat an additive container, the seat having a first inlet and a first outlet configured to couple to the additive container;
wherein the dispensing system is configured to selectively dispense an additive contained within an additive container seated in the seat in the drawer from the first outlet, and is configured to dispense the carbonated fluid from a second outlet separate from the first outlet.

2. The dispensing system of claim 1, wherein the drawer is slidably movable horizontally between an open position in which an additive container can be top-loaded into the drawer, and a closed position in which the drawer is fully disposed within the housing.

3. The dispensing system of claim 1, wherein the drawer includes at least one additional seat configured to seat at least one additional additive container.

4. The dispensing system of claim 3, wherein the seat and the at least one additional seat in the drawer are configured to seat additive containers in one of a radial formation and a linear formation.

5. The dispensing system of claim 3, wherein the second outlet is centrally disposed, and wherein the drawer is configured to seat an additive container peripherally of the second outlet.

6. The dispensing system of claim 1, wherein the dispensing system is configured to selectively introduce at least one gas into an additive container seated in the drawer to cause the additive container to dispense the additive from the first outlet.

7. The dispensing system of claim 6, wherein the inlet port is fluidly coupled to a pump, the pump being configured to selectively introduce the at least one gas into an additive container seated in the drawer.

8. The dispensing system of claim 1, wherein the drawer includes at least one viewing window configured to enable viewing of an additive container in the drawer when the drawer is in a closed position.

9. A dispensing system, comprising:
a housing;
a carbonation assembly at least partially contained within the housing and configured to selectively carbonate a fluid;
a top-loading carriage assembly coupled to the housing and having a plurality of isolated silos, each silo configured to receive an additive container; and
wherein the dispensing system is configured to dispense an additive disposed within an additive container disposed in each silo of the carriage assembly and to dispense a fluid that is selectively carbonated by the carbonation assembly into a receptacle, and wherein the top-loading carriage assembly includes an inlet port fluidly coupled to at least one air pump and configured to selectively introduce at least one gas into an additive container in each silo to cause the additive container to dispense an additive.

10. The dispensing system of claim 9, wherein the top-loading carriage assembly includes a lid movable between an open position and a closed position, and wherein the lid, in the closed position, is configured to apply a force to an additive container in each silo to couple an inlet port in the additive container with an outlet port in the housing.

11. (canceled)

12. The dispensing system of claim 11, wherein each of the isolated silos includes an inlet port and an outlet port, and wherein each inlet port is configured to allow at least one gas to be introduced into an additive container in the silo to cause the additive container to dispense an additive from the respective outlet port.

13. The dispensing system of claim 11, wherein each of the isolated silos are independently pressurizable to cause an additive container therein to compress and dispense an additive.
